(19) United States
(12) Patent Application Publication
(10) Pub. No.: US 2024/0296308 A1
(43) Pub. Date: Sep. 5, 2024

(54) Mixed-precision Neural Network Systems

(71) Applicant: SHANGHAITECH UNIVERSITY, Shanghai (CN)

(72) Inventors: Yueyang ZHENG, Shanghai (CN); Chaolin RAO, Shanghai (CN); Minye WU, Shanghai (CN); Xin LOU, Shanghai (CN); Pingqiang ZHOU, Shanghai (CN); Jingyi YU, Shanghai (CN)

(73) Assignee: SHANGHAITECH UNIVERSITY, Shanghai (CN)

(21) Appl. No.: 18/646,852

(22) Filed: Apr. 26, 2024

Related U.S. Application Data
(63) Continuation of application No. PCT/CN2021/130766, filed on Nov. 15, 2021.

(51) Int. Cl. G06N 3/04

(52) U.S. Cl. CPC G06N 3/04

(57) ABSTRACT

A computing system for encoding a machine learning model comprises a plurality of layers and a plurality of computation units. A first set of computation units are configured to process data at a first bit width. A second set of computation units are configured to process at a second bit width. The first bit width is higher than the second bit width. A memory is coupled to the computation units. A controller is coupled to the computation units and the memory. The controller is configured to provide instructions for encoding the machine learning model. The first set of computation units are configured to compute a first set of layers and the second set of computation units are configured to compute a second set of layers.

### CROSS REFERENCE TO RELATED APPLICATIONS

This application is a continuation application of International Application No. PCT/CN2021/130766, filed on Nov. 15, 2021, the entire contents of which are incorporated herein by reference.

### TECHNICAL FIELD

The present invention generally relates to computing systems for image rendering. More particularly, the present invention relates to a mixed-precision computing system for performing neural network-based image rendering.

### BACKGROUND

Image rendering techniques using machine learning models, such as neural networks, have been developed for rendering high-quality images. For example, neural radiance field techniques based on multilayer perceptrons have been recently developed to render photorealistic images from novel viewpoints. For instance, a neural radiance field of an object depicted in a scene can be encoded into a multilayer perceptron based on a training dataset comprising images depicting the object from various viewpoints in the scene. Once the multilayer perceptron is trained, color values of pixels can be obtained by the multilayer perceptron, and images of the object can be rendered. In general, multilayer perceptron-based computing systems can provide superior rendering performance. However, such computing systems require a lot of computing resources. As such, as computation complexity grows, current computing systems may not have sufficient computing headroom to handle image rendering within an allotted time period.

### SUMMARY

Described herein is a computing system for encoding a machine learning model comprising a plurality of layers. The computing system can comprise a plurality of computation units. A first set of computation units can be configured to process data at a first bit width. A second set of computation units can be configured to process at a second bit width. The first bit width can be higher than the second bit width. A memory can be coupled to the computation units. A controller can be coupled to the computation units and the memory. The controller can be configured to provide instructions for encoding the machine learning model. The first set of computation units can be configured to compute a first set of layers and the second set of computation units can be configured to compute a second set of layers.

In some embodiments, the machine learning model can be a neural network.

In some embodiments, the neural network can be a neural radiance field (NeRF).

In some embodiments, the first set of layers can comprise a layer at the beginning of the layers and a layer at the end of the layers.

In some embodiments, the first set of layers can comprise a layer associated with a concatenation operation.

In some embodiments, a layer can be configured to output data to a computation unit at a bit width associated with the next computation unit.

In some embodiments, at least one of the first set of layers can be configured to output data to a layer of the second set of layers at the second bit width associated with the layer.

In some embodiments, one of the first set of computation units can be configured to compute one of the second set of layers.

In some embodiments, the memory can be couple to a computation unit in accordance with the bit width of the computation unit.

In some embodiments, a computation unit can comprise at least one of a central processing unit, a graphics processing unit, or a field-programmable gate array.

Described herein is a computing implemented method. A computing system can encode a machine learning model comprising a plurality of layers. A first set of the layers can be configured to process data at a first bit width. A second set of the layers can be configured to process data at a second bit width. The first bit width can be higher than the second bit width. The computing system can compute data through a layer of the machine learning model in accordance with a first bit width associated with the layer. The computing system can output the computed data from the layer to a next layer at a second bit width associated with the next layer.

These and other features of the apparatuses, systems, methods, and non-transitory computer-readable media disclosed herein, as well as the methods of operation and functions of the related elements of structure and the combination of parts and economics of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for purposes of illustration and description only and are not intended as a definition of the limits of the invention.

### BRIEF DESCRIPTION OF THE DRAWINGS

Certain features of various embodiments of the present technology are set forth with particularity in the appended claims. A better understanding of the features and advantages of the technology will be obtained by reference to the following detailed description that sets forth illustrative embodiments, in which the principles of the invention are utilized, and the accompanying drawings of which:

FIG. 1 illustrates a machine learning model implemented in a computing system configured for image rendering, according to various embodiments of the present disclosure.

FIG. 2 illustrates an environment of configuring a mixed-precision neural network of a computing system configured for image rendering, according to various embodiments of the present disclosure.

FIG. 3 illustrates a computing system configured for image rendering, according to various embodiments of the present disclosure.

FIG. 4 illustrates a computing component that includes one or more hardware processors and a machine-readable storage media storing a set of machine-readable/machine-executable instructions that, when executed, cause the hardware processor(s) to perform a method, according to various embodiments of the present disclosure.

FIG. 5 is a block diagram that illustrates a computer system upon which any of various embodiments described herein may be implemented.

The figures depict various embodiments of the disclosed technology for purposes of illustration only, wherein the figures use like reference numerals to identify like elements. One skilled in the art will readily recognize from the following discussion that alternative embodiments of the structures and methods illustrated in the figures can be employed without departing from the principles of the disclosed technology described herein.

### DETAILED DESCRIPTION OF THE EMBODIMENTS

Described herein is an invention, rooted in technology, that mitigates the problems described above. In various embodiments, the invention can include a computing system implementing a mixed-precision neural network. The mixed-precision neural network can encode a neural radiance field. In some embodiments, the computing system can comprise a plurality of high-precision computation units coupled to a plurality of low-precision computation units over one or more data buses. Each computation unit can be configured to perform computations associated with a neural layer of the mixed-precision neural network. The high-precision computation units are configured to perform computations of neural layers requiring high precision, whereas the low-precision computation units are configured to perform computations of neural layers requiring low precision. In this way, the computing system can be configured to perform imaging rendering computations with mixed precision requirements. In some embodiments, the computing system can further comprise a memory and a controller, both, coupled to the high-precision computation units and the low-precision computation units over the one or more data buses. The memory can be configured to store data associated with inputs and outputs of the mixed-precision neural network. For example, the memory can be configured to store data associated with computations performed by the high-precision computation units and the low-precision computation units. The controller can be configured to instruct the memory to transmit data to and from various high-precision computation units and low-precision computation units. These and other features of the computing system are described herein.

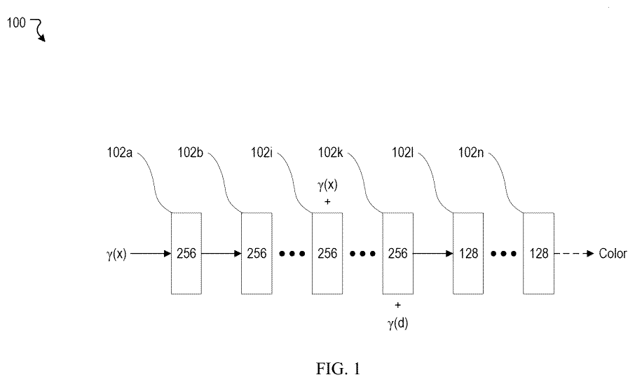

In general, neural radiance field-based image rendering techniques can have numerous advantages over conventional image rendering techniques. For example, unlike conventional image rendering techniques, neural radiance field-based image rendering techniques can synthesize (render) photo-realistic images in never-before-seen viewpoints. In various embodiments, neural radiance field-based image rendering techniques can be implemented using machine learning techniques. FIG. 1 illustrates a machine learning model 100 implemented in a computing system configured for image rendering, according to various embodiments of the present disclosure. The machine learning model 100 can be configured to encode a three-dimensional imaging space. In some embodiments, the machine learning model 100 can be based on a fully connected neural network (i.e., a multilayer perceptron) and the three-dimensional imaging space can be a neural radiance field (NeRF). During an encoding phase (i.e., a training phase), the machine learning model 100 can be encoded with color values of points (i.e., voxels) in the three-dimensional space based on coordinates of a continuous scene representation. In some embodiments, the continuous scene representation can be represented as five-dimensional vectors. In such embodiments, the coordinates of the continuous scene representation can be represented as (x, y, z, θ, Ø), where (x, y, z) represent a position of a point (i.e., a voxel) in the three-dimensional imaging space and (θ, Ø) represent a camera ray direction of a point in the three-dimensional space. These coordinates can be optimized through the machine learning model 100 during the encoding phase. In some embodiments, during the encoding phase, a position encoding technique can be used to map the coordinates of the continuous scene representation from five dimensions to a higher dimensional space. In this way, the machine learning model 100 can be encoded to be more sensitive to high-frequency color variations and geometries (e.g., features of images) so that high fidelity images can be rendered. In various embodiments, Fourier feature mapping techniques can be used to map the coordinates of the continuous scene representation to a higher dimensional space.

In some embodiments, the position encoding technique can be expressed as follows:

$$γ ( p ) = ( sin ( {2}^{0} π p ) , cos ( {2}^{0} π p ) , … , sin ( {2}^{L - 1} π p ) , cos ( {2}^{L - 1} π p ) ) \qquad ( 1 )$$

where γ(p) is the position encoding function, p is values of the coordinates, and L is a constant. In some embodiments, L equals ten when p is x (i.e., positions) and four when p is d (i.e., camera ray directions). Using the expression above, coordinates of a continuous scene representation can be mapped to a higher dimension space.

Now referring back to FIG. 1, the machine learning model 100 can comprise a plurality of layers 102a-102n. In some embodiments, the plurality of layers 102-102n can be fully connected neural layers. A fully connected neural layer is a neural layer in which neurons (i.e., perceptrons) of the neural layer are connected to neurons of the next neural layer. In FIG. 1, γ(x) represents position encoding of positions of points (i.e., (x, y, z)) in the three-dimensional space, γ(d) represents position encoding of camera ray directions of points (i.e., (θ, Ø)) in the three-dimensional space. Further, in FIG. 1, symbol “+” represents a concatenation operation, a solid arrow represents an activation function, such as a rectified linear unit (ReLU) function, and a dashed arrow represents a differentiable function, such as a sigmoid function.

In some embodiments, each of the plurality of layers 102a-102n can be expressed as follows:

$${O}_{v} = φ ( {B}_{v} + {\sum }_{i = 0}^{{N}_{i} - 1} {I}_{i} \times {W}_{v , i} ) , where 0 \leq v \leq {N}_{o} \qquad ( 2 )$$

where Nᵢ represents a number of input neurons, Nₒ represents a number of output neurons, O, I, W, B are matrices of output neurons, input neurons (i.e., activations), weights (i.e., filters), and biases, respectively.

As shown in FIG. 1, position encoding of positions of points (i.e., γ(x)) can be processed through layer 102a. Layer 102a can compute an output in accordance with expression (2) above. The output is then processed through layer 102b. Layer 102b can then compute another output in accordance with expression (2) above. These computations continue until the position encoding of positions is processed through rest of the layers 102i-102n. In some embodiments, one of the layers 102i-102n can be further configured to concatenate an output provided by the previous layer with the position encoding of positions that was previously provided to layer 102a. For example, layer 102i can concatenate (i.e., “+”) an output provided by the previous layer with the position encoding of positions (i.e., γ(x)) before layer 102i processes its output. In some embodiments, another one of the layers 102i-102n can be configured to concatenate (i.e., “+”) an output provided by the previous layer with position encoding of camera ray directions of points (i.e., γ(d)). For example, layer 102k can concatenate an output provided by the previous layer with the position encoding of camera ray directions before layer 102k processes its output. Once the position encoding of positions and the position encoding of camera ray directions are processed through the plurality of layers 102a-102n, color values of pixels can be obtained. For example, layer 102n is the last layer of the machine learning model 100. In this example, layer 102n can be configured to output color values of pixels.

In some embodiments, a color value of a pixel can be determined by integrating points (i.e., voxels) in the three-dimensional imaging space along a path of a camera ray associated with the pixel. An integration of points along a camera ray can be expressed as follows:

$$C ( r ) = {\sum }_{i = 1}^{N} {T}_{i} ( 1 - exp ( - {σ}_{i} {δ}_{i} ) ) {c}_{i} , where {T}_{i} = exp ( - {\sum }_{j = 1}^{i - 1} {σ}_{j} {δ}_{j} ) \qquad ( 3 )$$

where C(r) is the color value of the pixel, σᵢ is a distance between points, cᵢ is color of each point along the camera ray, and δᵢ is density (i.e., opacity) of each point along the camera ray. In some embodiments, layer 102n can be configured to perform computations associated with expression (3). In other embodiments, a specialized logic or processor can be configured to perform computations associated with expression (3). Many variations are possible and contemplated.

In various embodiments, each of the plurality of layers 102a-102n can comprise a particular number of neurons. For example, as shown in FIG. 1, the layers 102a, 102b, 102i, 102k can comprise 256 neurons and the layers 102l, 102n can comprise 128 neurons. In general, each of the plurality of layers 102a-102n can comprise any number of suitable neurons needed to execute computations of expression (2) and expression (3).

In general, the machine learning model 100, as discussed in relation to FIG. 1, is configured to perform computations in floating-point formats. As such, the machine learning model 100 has a lot of redundancy. Further, when performing computations in floating-point formats, the computations may require more addressable memory space (i.e., high memory usage) than other formats. For example, computations based on 10-bit floating-point formats require 10-bit addressable memory space, whereas computations based on binary formats require 1-bit of addressable memory space. In general, computations performed in floating-point formats can offer higher computational precision. For example, computations performed based on 10-bit floating-point formats can offer higher precision (i.e., more digits) than computations performed using 5-bit floating-point formats. However, computations performed based on floating-point formats can increase computation complexity and memory usage. As such, by altering precisions associated with the plurality of layers 102a-102n, computation of color values of pixels through the machine learning model 100 can be accelerated because fewer “bits” are involved in computations, thereby reducing computation complexity and memory usage.

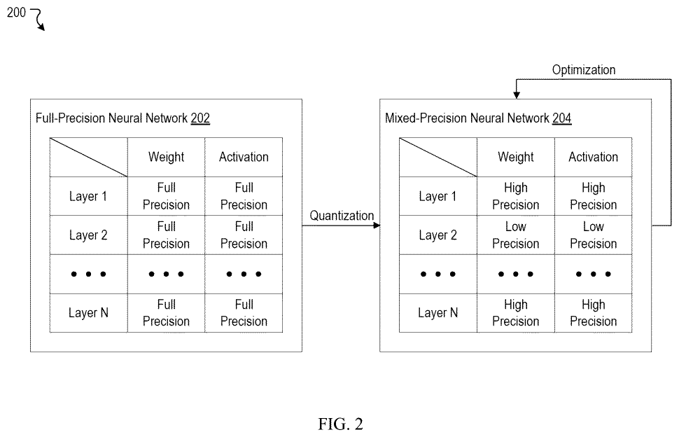

FIG. 2 illustrates an environment 200 of configuring a mixed-precision neural network 204 of a computing system configured for image rendering, according to various embodiments of the present disclosure. The computing system can utilize the mixed-precision neural network 204 to render images. In general, layers of a neural network encoding a neural radiance field can be quantized to reduce a bit-width needed for computations. For example, a layer of a neural network may require 10-bit of addressable memory space to perform computations at certain precision. In this example, if this precision is not needed or is unnecessary, the computations may be performed at a reduced bit-width (e.g., 5 bits) to minimize memory usage and reduce computation complexity. In this way, the computing system can accelerate image rendering. As such, when designing the mixed-precision neural network 204, quantization levels (i.e., an extent of bit-width reduction) needed for each layer need to be independently considered. Specifically, weights and activations of each layer are of primary consideration when determining quantization levels.

One goal of implementing the mixed-precision neural network 204 is to ensure no accuracy loss for color values of pixels. In implementing the mixed-precision neural network 204, three general factors or rules-of-thumb have been identified or observed. Each of these factors will be discussed in further detail below.

Factor 1. It has been generally determined or observed that, to generate high precision color values (i.e., rendering high-quality images), weights and activations of layers need to be higher precision, while other parameters (e.g., bias) of the layers can be lower precision. This approach has been observed to reduce computation complexity.

Factor 2. It has been generally determined or observed that, to generate high precision color values, layers that are associated with inputs, outputs, or concatenations require high precision, while layers that are not associated with inputs, outputs, or concatenations can be compressed to reduced precision. For example, consider the machine learning model 100 of FIG. 1. In FIG. 1, layer 102a is associated with an input (e.g., γ(x)), layers 102i, 102k are associated with concatenations (e.g., γ(x)+ and γ(d)+), and layer 102n is associated with an output (e.g., “Color”). As such, in this example, layers 102a, 102i, 102k, and 102n need to be high precision, while other layers (e.g., layers 102b, 102l) do not need to be high precision. This approach has been observed to reduce computation complexity with minimal impact on image quality.

Factor 3. It has been generally determined that background and object information may also influence quality of color values. In this regard, a deviation of color values may occur when layers are not of sufficient precision.

To summarize, as a general rule, the higher the precision of layers, the higher the quality of rendered images; and the higher the precision of layers, the higher the computation complexity. As such, as the mixed-precision neural network 204 is configured and implemented in the computing system, the aforementioned factors are considered in determining precisions needed for each layer to balance image quality with computation efficiency.

Now referring to FIG. 2, the environment 200 can include a full-precision neural network 202. As shown in FIG. 2, in the full-precision neural network 202, weights and activations of layers are computed in full precision. In this regard, full precision means high precision needed to render high-quality images (or sufficient quality images). As discussed above, such an implementation of a neural network is not computationally efficient. For instance, high-precision computations require greater memory usage or addressable memory space. By applying the three factors discussed above, during a quantization process, different precisions can be applied to different layers to increase computation efficiency and reduce computation complexity, while still maintaining image quality. As shown in FIG. 2, weights and activations of layers of the mixed-precision neural network 204 can be computed in different precisions. For example, weights and activations of “Layer 1” and “Layer N” of the mixed-precision neural network 204 are computed in high precision (i.e., a first bit-width), while weight and activation of “Layer 2” of the mixed-precision neural network 204 are computed in low precision (i.e., a second bit-width). This differing precision being applied to different layers of the mixed-precision neural network 204 is a direct result of applying Factor 2, as discussed above, to the full-precision neural network 202. Here, in the full-precision neural network 202, because “Layer 1” and “Layer N” are associated with an input and an output, respectively, computations performed through “Layer 1” and “Layer N” require high-precision. Similarly, because “Layer 2” is not associated with an input, an output, or a concatenation, computations performed through “Layer 2” do not require high-precision and low-precision computations are sufficient. In some embodiments, the mixed-precision neural network 204 can undergo continuous optimization to alter precisions of its layers. For example, precisions of layers can change according to changes to a neural network. For instance, a computing system implementing the mixed-precision neural network 204 can be adapted to render images using different neural networks.

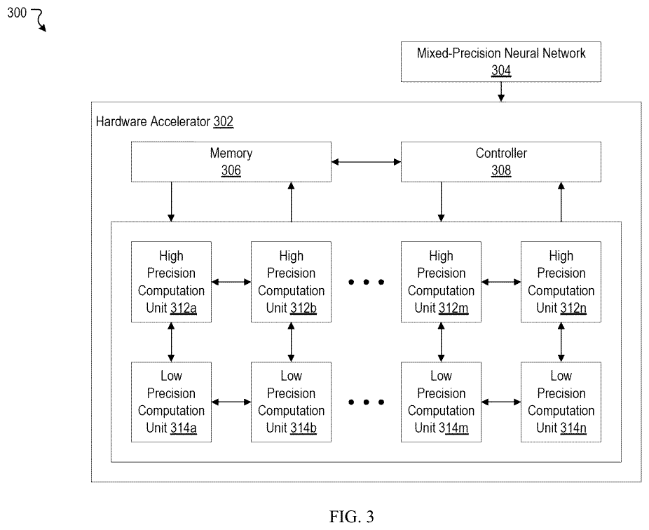

FIG. 3 illustrates a computing system 300 configured for image rendering, according to various embodiments of the present disclosure. As shown in FIG. 3, in some embodiments, the computing system 300 can include a hardware accelerator 302 and a mixed-precision neural network 304. The hardware accelerator 302 can be coupled to the mixed-precision neural network 304 over one or more data buses or networks, such as over Ethernet, Wi-Fi, or PCI-E bus. In some embodiments, the mixed-precision neural network 204 of FIG. 2 can be implemented as the mixed-precision neural network 304.

In some embodiments, the hardware accelerator 302 can include a memory 306, a controller 308, a plurality of high precision computation units 312a-312n, and a plurality of low precision computation units 314a-314n. The memory 306, the controller 308, the high precision computation units 312a-312n, and the low precision computation units 314a-314n can be bi-directionally coupled to one another over one or more data buses. The high precision computation units 312a-312n can be configured to perform high precision computations or perform computations in high bit-widths. Likewise, the low precision computation units 314a-314n can be configured to perform low precision computations or perform computations in low bit-widths.

In some embodiments, each of the high precision computation units 312a-312n and the low precision computation units 314a-314n can be configured to execute computations associated with a layer of the mixed-precision neural network 304. In some embodiments, each computation unit can be configured to perform computations of a layer according to precision allocated to or determined for the layer. For example, high precision computation unit 312a can be configured to perform computations associated with a high precision layer (e.g., “Layer 1” or “Layer N” of the mixed-precision neural network 204 of FIG. 2). As another example, low precision computation unit 314a can be configured to perform computations associated with a low precision layer (e.g., “Layer 2” of the mixed-precision neural network 204 of FIG. 2). In some embodiments, each computation unit can be further configured to quantize a layer according to precision of the next layer. For example, continuing from the example above, assume that data is processed in a sequence from “Layer 1” to “Layer 2.” In this example, high precision computation unit 312a can quantize its output from high precision to low precision (i.e., from a high bit-width to a low bit-width) so that the output is compatible with low precision computation unit 314a. Once each computation unit finishes its computation, the computation unit can store its output to the memory 306. In such cases, another computation unit can access the output from the memory 306. For example, continuing from the examples above, high precision computation unit 312a can store the quantized output to the memory 306. Low precision computation unit 314a can then access the quantized output from the memory 306. In various embodiments, in addition to performing high precision computations, any of the high precision computation units 312a-312n can be configured to perform low precision computations. However, the reverse is not true. Unlike the high precision computation units 312a-312n, the low precision computation units 314a-314n can only perform low precision computations. For example, in some embodiments, high precision computation unit 312a can be configured to perform low precision computations. However, low precision computation unit 314a cannot be configured to perform high precision computations.

In some embodiments, a total number of the high precision computation units 312a-312b and the low precision computation units 314a-314b can exceed a total number of layers of the mixed-precision neural network 304. In such embodiments, software running on the computing system 300 be can be configured to instruct a subset of the high precision computation units 312a-312b and/or the low precision computation units 314a-314b to perform computations associated with layers of the mixed-precision neural network 304. For example, assume that the mixed-precision neural network 304 comprises eight layers of which four layers require high precision and the other four layers require low precision. In this example, the software can be configured to instruct the high precision computation units 312a, 312b, 312m, 312n to perform computations of the four layers requiring high precision and the low precision computation units 314a, 314b, 314m, 314n to perform computations of the four layers requiring low precision. In some embodiments, the high precision computation units 312a-312n and the low precision computation units 314a-314n can be implemented based on one or more central processing units (CPUs), graphics processing units (GPUs), or field-programmable gate arrays (FPGAs). For example, in some embodiments, the high precision computation units 312a-312n and the low precision computation units 314a-314n can be implemented based on one or more processing cores of a CPU or a GPU. As another example, in some embodiments, the high precision computation units 312a-312n and the low precision computation units 314a-314n can be implemented by configuring or programming computation logic blocks of FPGAs. Many variations are possible. For example, in some embodiments, the high precision computation units 312a-312n can be implemented based on CPUs and the low precision computation units 314a-314n can be implemented based on FPGAs.

In some embodiments, as shown in FIG. 3, the high precision computation units 312a-312n and the low precision computation units 314a-314n can be adjacently interconnected. In this way, an output from a computation unit can be transmitted either to a low precision computation unit or a high precision computation as required by the mixed-precision neural network 304. For example, in some embodiments, high precision computation unit 312a can directly transfer its output to cither high precision computation unit 312b or the precision computation unit 314b. Many variations are possible.

In some embodiments, the memory 306 can be configured to store outputs or quantized outputs from the high precision computation units 312a-312n and the low precision computation units 314a-314n. In some embodiments, a size of the memory 306 can be adjusted based on a computation flow of the mixed-precision neural network 304. In this regard, a computation flow can refer to transmission time between the memory 306 and the high precision computation units 312a-312n and the low precision computation units 314a-314n. For example, when instructing a particular computation unit to perform computations of a layer, the software can take into account transmission time from the memory 306 to the particular computation unit so that idle time of the particular computation unit is minimized. In general, the size of the memory 306 can be smaller than a full-precision neural network from which the mixed-precision neural network 304 was derived (e.g., the full-precision neural network 202 of FIG. 2). This is because output widths of the low precision computation units 314a-314n are small. For example, in some embodiments, the memory 306 can be configured to have a width of 20 bits in a memory array (e.g., an array of memory units). In this example, assume that high precision outputs are 10 bits and low precision outputs are 5 bits. Therefore, in this example, each memory array can store two high precision outputs (i.e., 20/10) or four low precision outputs (i.e., 20/5). As such, in this way, the size of the memory 306 can be reduced when comparing to a memory size needed for computations for a full-precision neural network.

In some embodiments, the controller 308 can be configured to instruct the high precision computation units 312a-312n and the low precision computation units 314a-314n to quantize their outputs at a particular precision. For example, in some embodiments, the controller 308 can instruct high precision computation unit 312a to quantize its output before transmitting to low precision computation unit 314a. In some embodiments, the controller 308 can be further configured to instruct particular memory arrays in the memory 306 at which to store outputs or quantized outputs. In some embodiments, the controller 308 can receive status from the high precision computation units 312a-312n, the low precision computation units 314a-314n, and the memory 306 to synchronize data transformation and computation. For example, continuing from the example above, in some embodiments, the controller 308 can instruct high precision computation unit 312a to transmit its output to low precision computation unit 314a, instead of low precision computation unit 314n, to minimize transmission time and idling time. As another example, in some embodiments, if no low precision computation units are available, the controller 308 can instruct a particular high precision computation unit to perform low precision computations. Many variations are possible.

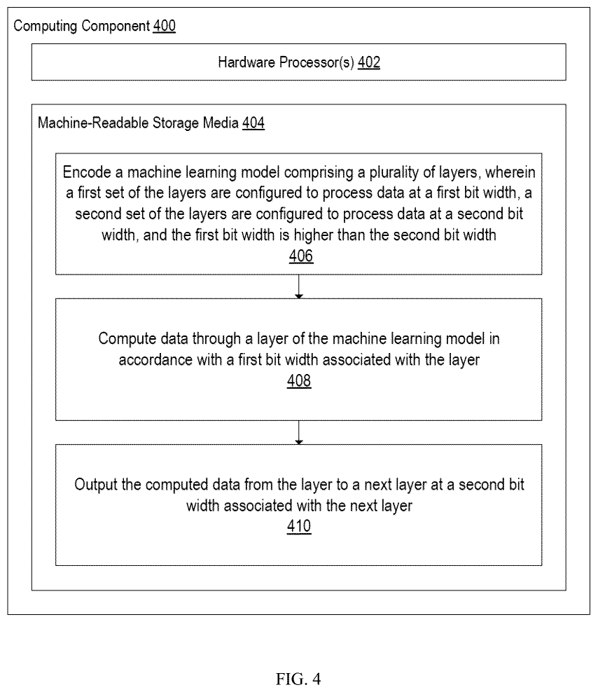

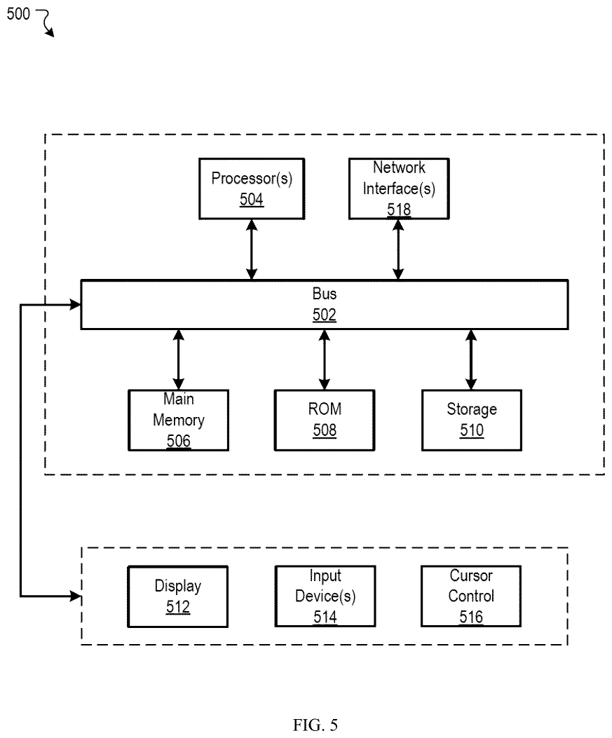

FIG. 4 illustrates a computing component 400 that includes one or more hardware processors 402 and a machine-readable storage media 404 storing a set of machine-readable/machine-executable instructions that, when executed, cause the hardware processor(s) 402 to perform a method, according to various embodiments of the present disclosure. The computing component 400 may be, for example, the computing system 500 of FIG. 5. The hardware processors 402 may include, for example, the processor(s) 504 of FIG. 5 or any other processing unit described herein. The machine-readable storage media 404 may include the main memory 506, the read-only memory (ROM) 508, the storage 510 of FIG. 5, and/or any other suitable machine-readable storage media described herein.

At block 406, the processor 402 can encode a machine learning model comprising a plurality of layers. A first set of the layers are configured to process data at a first bit width. A second set of the layers are configured to process data at a second bit width. The first bit width is higher than the second bit width.

At block 408, the processor 402 can compute data through a layer of the machine learning model in accordance with a first bit width associated with the layer.

At block 410, the processor 402 can output the computed data from the layer to a next layer at a second bit width associated with the next layer.

The techniques described herein, for example, are implemented by one or more special-purpose computing devices. The special-purpose computing devices may be hard-wired to perform the techniques, or may include circuitry or digital electronic devices such as one or more application-specific integrated circuits (ASICs) or field programmable gate arrays (FPGAs) that are persistently programmed to perform the techniques, or may include one or more hardware processors programmed to perform the techniques pursuant to program instructions in firmware, memory, other storage, or a combination.

FIG. 5 is a block diagram that illustrates a computer system 500 upon which any of various embodiments described herein may be implemented. The computer system 500 includes a bus 502 or other communication mechanism for communicating information, one or more hardware processors 504 coupled with bus 502 for processing information. A description that a device performs a task is intended to mean that one or more of the hardware processor(s) 504 performs.

The computer system 500 also includes a main memory 506, such as a random access memory (RAM), cache and/or other dynamic storage devices, coupled to bus 502 for storing information and instructions to be executed by processor 504. Main memory 506 also may be used for storing temporary variables or other intermediate information during execution of instructions to be executed by processor 504. Such instructions, when stored in storage media accessible to processor 504, render computer system 500 into a special-purpose machine that is customized to perform the operations specified in the instructions.

The computer system 500 further includes a read only memory (ROM) 508 or other static storage device coupled to bus 502 for storing static information and instructions for processor 504. A storage device 510, such as a magnetic disk, optical disk, or USB thumb drive (Flash drive), etc., is provided and coupled to bus 502 for storing information and instructions.

The computer system 500 may be coupled via bus 502 to output device(s) 512, such as a cathode ray tube (CRT) or LCD display (or touch screen), for displaying information to a computer user. Input device(s) 514, including alphanumeric and other keys, are coupled to bus 502 for communicating information and command selections to processor 504. Another type of user input device is cursor control 516. The computer system 500 also includes a communication interface 518 coupled to bus 502.

Unless the context requires otherwise, throughout the present specification and claims, the word “comprise” and variations thereof, such as, “comprises” and “comprising” are to be construed in an open, inclusive sense, that is as “including, but not limited to.” Recitation of numeric ranges of values throughout the specification is intended to serve as a shorthand notation of referring individually to each separate value falling within the range inclusive of the values defining the range, and each separate value is incorporated in the specification as it were individually recited herein. Additionally, the singular forms “a,” “an” and “the” include plural referents unless the context clearly dictates otherwise. The phrases “at least one of,” “at least one selected from the group of,” or “at least one selected from the group consisting of,” and the like are to be interpreted in the disjunctive (e.g., not to be interpreted as at least one of A and at least one of B).

Reference throughout this specification to “one embodiment” or “an embodiment” means that a particular feature, structure or characteristic described in connection with the embodiment is included in at least one embodiment of the present invention. Thus, the appearances of the phrases “in one embodiment” or “in an embodiment” in various places throughout this specification are not necessarily all referring to the same embodiment, but may be in some instances. Furthermore, the particular features, structures, or characteristics may be combined in any suitable manner in one or more embodiment.

A component being implemented as another component may be construed as the component being operated in a same or similar manner as the another component, and/or comprising same or similar features, characteristics, and parameters as the another component.

What we claim is:

1. A computing system for encoding a machine learning model comprising a plurality of layers, comprising:
a plurality of computation units, wherein a first set of computation units are configured to process data at a first bit width, a second set of computation units are configured to process at a second bit width, and the first bit width is higher than the second bit width;
a memory coupled to the computation units; and
a controller coupled to the computation units and the memory, wherein the controller is configured to provide instructions for encoding the machine learning model, the first set of computation units are configured to compute a first set of layers, and the second set of computation units are configured to compute a second set of layers.

2. The computing system according to claim 1, wherein the machine learning model is a neural network.

3. The computing system according to claim 2, wherein the neural network is a neural radiance field (NeRF).

4. The computing system according to claim 1, wherein the first set of layers comprise a layer at the beginning of the layers and a layer at the end of the layers.

5. The computing system according to claim 1, wherein the first set of layers comprise a layer associated with a concatenation operation.

6. The computing system according to claim 1, wherein a layer is configured to output data to a computation unit at a bit width associated with the next computation unit.

7. The computing system according to claim 1, wherein at least one of the first set of layers is configured to output data to a layer of the second set of layers at the second bit width associated with the layer.

8. The computing system according to claim 1, wherein one of the first set of computation units is configured to compute one of the second set of layers.

9. The computing system according to claim 1, wherein the memory is couple to a computation unit in accordance with the bit width of the computation unit.

10. The computing system according to claim 1, wherein a computation unit comprises at least one of a central processing unit, a graphics processing unit, or a field-programmable gate array.

11. A computer-implemented method comprising:
encoding, by a computing system, a machine learning model comprising a plurality of layers, wherein a first set of the layers are configured to process data at a first bit width, a second set of the layers are configured to process data at a second bit width, and the first bit width is higher than the second bit width;
computing, by the computing system, data through a layer of the machine learning model in accordance with a first bit width associated with the layer; and
outputting, by the computing system, the computed data from the layer to a next layer at a second bit width associated with the next layer.

12. The computer-implemented method according to claim 11, wherein the machine learning model is a neural network.

13. The computer-implemented method according to claim 12, wherein the neural network is a neural radiance field (NeRF).

14. The computer-implemented method according to claim 11, wherein an input layer and an output layer of the machine learning model are configured to process data at the first bit width.

15. The computer-implemented method according to claim 11, wherein layers of the machine learning model that are associated with concatenation operations are configured to process data at the first bit width.

16. The computer-implemented method according to claim 11, wherein the computing system comprises a plurality of first computation units and a plurality of second computation units.

17. The computer-implemented method according to claim 16, wherein the first computation units are configured to perform computations associated with the first set of the layers.

18. The computer-implemented method according to claim 17, wherein the first computation units are further configured to perform computations associated with the second set of the layers.

19. The computer-implemented method according to claim 16, wherein the second computation units are configured to perform computations associated with the second set of the layers.

20. The computer-implemented method according to claim 16, wherein the first computation units and the second computation units comprise at least one of a central processing unit, a graphics processing unit, or a field-programmable gate array.
